(19) United States
(12) Patent Application Publication
(10) Pub. No.: US 2023/0044915 A1
(43) Pub. Date: Feb. 9, 2023

(54) MICROFLUIDIC ARRANGEMENT FOR CAPILLARY DRIVEN FLUIDIC CONNECTION

(71) Applicant: miDiagnostics NV, Heverlee (BE)

(72) Inventors: Klaas DE GREVE, Kessel-Io (BE); Murray J. WHYTE, Clackmannashire (GB); Matthew SPRINGER, Gers (FR); Oliver DAVIES, Lenark (GB)

(21) Appl. No.: 17/758,658

(22) PCT Filed: Jan. 14, 2021
(86) PCT No.: PCT/EP2021/050709

§ 371 Date: Jul. 12, 2022

(30) Foreign Application Priority Data
Jan. 14, 2020 (EP) 20151782.8

(51) Int. Cl. B01L 3/00

(52) U.S. Cl. CPC B01L 3/50273; B01L 2400/0406; B01L 2200/027; B01L 2300/0877; B01L 2300/161

(57) ABSTRACT

The present inventive concept relates to a microfluidic arrangement (1) for capillary driven fluidic connection between capillary flow channels (8, 16). The microfluidic arrangement (1) comprises: a first microfluidic system (4) comprising a first surface (5), and a first capillary flow channel (8), wherein the first capillary flow channel (8) has an elongation in a first plane, and the first surface comprises an outlet opening (9) in a plane different from the first plane, the outlet opening defining an outlet area (35) in the first surface and being adapted to allow fluidic communication with the first capillary flow channel thereby forming a flow outlet (12) of the first capillary flow channel, and a second microfluidic system (6) comprising a second surface (7) and a second capillary flow channel (16), wherein the second capillary flow channel (16) has an elongation in a second plane parallel to the first plane, and a portion of the second surface (7) comprises an inlet opening (13) in a plane different from the second plane, the inlet opening defining an inlet area (33) in the second surface and being adapted to allow fluidic communication with the second capillary flow channel thereby forming a flow inlet (20) of the second capillary flow channel, wherein the first microfluidic system (4) and the second microfluidic system (6) are arranged with the first and the second surfaces in contact such that the flow outlet (12) and the flow inlet (20) are interfaced, thereby allowing capillary driven fluidic connection between the first and the second capillary flow channels (8, 16), wherein the outlet area (35) overlaps at least a portion of the inlet area (33), said at least a portion of the inlet area (33) overlapped by the outlet area (35) being smaller than the outlet area (35).

### TECHNICAL FIELD

The present inventive concept relates to a microfluidic arrangement for capillary driven fluidic connection between capillary flow channels.

### BACKGROUND

Connection between different capillary driven fluidic components is problematic and often results in undesired stopping of the capillary driven flows. In particular, fluid flows are at risk at stopping at the interface between two capillary driven fluidic components.

For example, a reliable connection without undesired stops of capillary flows between a silicon microfluidic chip and a cartridge holding the chip is problematic.

There is, thus, a need for arrangements providing reliable connection or interface between capillary driven microfluidic systems, which do not suffer from problems relating to prior art. In particular there is a need for provision of reliable connection or interface between a silicon microfluidic chip and a cartridge.

### SUMMARY

One aim of the present inventive concept is solving at least one problem with prior art. A particular aim of the inventive concept is to solve problems with providing an arrangement with a fluidic connection between capillary flow channels of different microfluidic systems.

According to a first aspect of the present inventive concept there is provided a microfluidic arrangement for capillary driven fluidic connection between capillary flow channels, the microfluidic arrangement comprising:

a first microfluidic system comprising a first surface, and a first capillary flow channel, wherein

the first capillary flow channel has an elongation in a first plane, and

the first surface comprises an outlet opening in a plane different from the first plane, the outlet opening defining an outlet area in the first surface and being adapted to allow fluidic communication with the first capillary flow channel thereby forming a flow outlet of the first capillary flow channel,

and

a second microfluidic system comprising a second surface and a second capillary flow channel, wherein

the second capillary flow channel has an elongation in a second plane parallel to the first plane, and

a portion of the second surface comprises an inlet opening in a plane different from the second plane, the inlet opening defining an inlet area in the second surface and being adapted to allow fluidic communication with the second capillary flow channel thereby forming a flow inlet of the second capillary flow channel,

wherein the first microfluidic system and the second microfluidic system (6) are arranged with the first and the second surfaces in contact such that the flow outlet and the flow inlet are interfaced, thereby allowing capillary driven fluidic connection between the first and the second capillary flow channels, wherein
the outlet area overlaps at least a portion of the inlet area, said at least a portion of the inlet area overlapped by the outlet area being smaller than the outlet area.
   According to a second aspect of the present inventive concept there is provided a method for manufacturing a second microfluidic system for interfacing with a first microfluidic system (4) comprising a first surface (5), and a first capillary flow channel (8), wherein the first capillary flow channel (8) has an elongation in a first plane, and the first surface comprises an outlet opening (9) in a plane different from the first plane, the outlet opening defining an outlet area (35) in the first surface and being adapted to allow fluidic communication with the first capillary flow channel thereby forming a flow outlet (12) of the first capillary flow channel, the second microfluidic system comprising a second surface having an inlet opening, and a second capillary flow channel communicating with the inlet opening, wherein the second microfluidic system further comprises a stack of layers comprising a first layer and a second layer, and a spacer layer between the first and the second layer, the method comprising:

manufacturing the spacer layer by laser cutting an elongated cut-out in a spacer material, the elongated cut-out defining the capillary flow channel of the microfluidic system,

stacking the spacer layer with the second layer, optionally with one or more additional layers between the spacer layer and the second layer,

cutting a hole through the second layer, and optionally through the one or more additional layers, into the elongated cut-out of the spacer layer with a a short pulse laser, thereby making the inlet opening communicating with the capillary flow channel,

arranging a first layer on top of the spacer layer.

According to a third aspect of the present inventive concept, there is provided a device comprising the microfluidic arrangement according to the first aspect for medical or diagnostic use.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 is a schematic illustration of a cross-sectional view of a microfluidic arrangement.

FIG. 2 is a schematic illustration of a cross-sectionals view of a microfluidic arrangement.

FIGS. 3(a)-(h) are schematic illustrations of inlet and outlet areas and overlapping areas.

FIGS. 4(a)-(c) illustrate overlapping inlet and outlet areas.

FIG. 5 is a schematic illustration of overlapping inlet and outlet areas.

FIG. 6 is a schematic illustration of a cross-sectional view of a microfluidic arrangement.

FIGS. 7(a) and (b) are schematic illustrations of a microfluidic arrangement comprising a stack of layers.

FIG. 8 is a schematic illustration of a cross-sectionals view of a microfluidic arrangement comprising a hole-member.

FIGS. 9(a) and (b) are schematic illustrations of a microfluidic arrangement comprising a stack of layers.

FIG. 10 is a schematic illustration of a method according to an inventive concept.

### DETAILED DESCRIPTION

In view of the above, it would be desirable to provide an arrangement for capillary driven fluidic connection between a first and a second microfluidic system, which are not compromised by problems associated with prior art. One objective of the present inventive concept is to address this issue and to provide solutions to at least one problem or need related to prior art. Further and alternative objectives may be understood from the following.

Disclosures herein relating to one inventive aspect of the inventive concept generally may further relate to one or more of the other aspect(s) of the inventive concept.

It will be appreciated that the inventive concept at least in part is based on an unexpected finding that by interfacing two microfluidic systems via an interface wherein an outlet area overlaps at least a portion of the inlet area, said at least a portion of the inlet area overlapped by the outlet area being smaller than the outlet area problems relating to the connections may be solved or reduced. Further unexpected findings include that this can be realised by the outlet being larger than the inlet, in which case the outlet may fully overlap the inlet, or that the outlet and the inlet may be of same sizes or even that the inlet may be larger than the outlet, for which cases the overlap is so arranged that the overlapped area is smaller than the outlet area. It was unexpectedly found that such overlaps results in benefits including, for example, improved fluidic properties without blockage of the capillary flow between the microfluidic systems.

According to a first aspect of the present inventive concept there is provided

a microfluidic arrangement for capillary driven fluidic connection between capillary flow channels, the microfluidic arrangement comprising:

a first microfluidic system comprising a first surface, and a first capillary flow channel, wherein

the first capillary flow channel has an elongation in a first plane, and

the first surface comprises an outlet opening in a plane different from the first plane, the outlet opening defining an outlet area in the first surface and being adapted to allow fluidic communication with the first capillary flow channel thereby forming a flow outlet of the first capillary flow channel,

and

a second microfluidic system comprising a second surface and a second capillary flow channel, wherein

the second capillary flow channel has an elongation in a second plane parallel to the first plane, and

a portion of the second surface comprises an inlet opening in a plane different from the second plane, the inlet opening defining an inlet area in the second surface and being adapted to allow fluidic communication with the second capillary flow channel thereby forming a flow inlet of the second capillary flow channel,

wherein the first microfluidic system and the second microfluidic system (6) are arranged with the first and the second surfaces in contact such that the flow outlet and the flow inlet are interfaced, thereby allowing capillary driven fluidic connection between the first and the second capillary flow channels, wherein
the outlet area overlaps at least a portion of the inlet area, said at least a portion of the inlet area overlapped by the outlet area being smaller than the outlet area.
   The arrangement comprising a first microfluidic system comprising a first surface, and a first capillary flow channel, wherein the first capillary flow channel has an elongation in a first plane, and the first surface comprises an outlet opening in a plane different from the first plane, the outlet opening defining an outlet area in the first surface and being adapted to allow fluidic communication with the first capillary flow channel thereby forming a flow outlet of the first capillary flow channel, allows for capillary driven flows of liquid through and out of the first microfluidic system.

The arrangement comprising a second microfluidic system comprising a second surface and a second capillary flow channel, wherein the second capillary flow channel has an elongation in a second plane parallel to the first plane, and a portion of the second surface comprises an inlet opening in a plane different from the second plane, the inlet opening defining an inlet area in the second surface and being adapted to allow fluidic communication with the second capillary flow channel thereby forming a flow inlet of the second capillary flow channel, allows for capillary driven flow of liquid into the second microfluidic system.

The first microfluidic system and the second microfluidic system being arranged with the first and the second surfaces in contact such that the flow outlet and the flow inlet are interfaced, allows for provision of an capillary driven fluidic connection between the first and the second capillary flow channels, thereby enabling flow of liquid between the microfluidic systems.

The first and the second microfluidic systems comprising a first surface and a second surface, respectively, allows for efficient interfacing of the microfluidic systems, for example, by contacting at least a portion of the first surface with at least a portion of the second surface.

The outlet area overlapping at least a portion of the inlet area provides for fluidic communication between the first and the second capillary flow channels. The at least a portion of the inlet area overlapped by the outlet area being smaller than the outlet area provides for capillary driven flows between the first and the second capillary flow channels. It has unexpectedly been found that the present inventive concept, including the definitions of the inlet area overlapped by the outlet area, allows efficient unperturbed flows, even capillary driven flows, between the first and the second flow channels, as compared to, for example, if the overlapped area would have been larger.

The second capillary flow channel may further comprise a second flow outlet arranged to emit the liquid from the second capillary flow channel. Thereby, flow of liquid out of the second microfluidic system may be enabled.

Arranging the first and the second surfaces in contact such that the flow outlet and the flow inlet are interfaced, may be realised in a plurality of suitable ways. The surfaces may be pressed tightly together, such as by clamping the first and the second microfluidic systems together with the first and second surfaces facing each other with the outlet and the inlet openings suitably aligned or positioned. A layer having sealing properties, for example a flexible or compressible layer of material may be positioned between the first and the second microfluidic systems. The layer, or another material such as a glue or sealing liquid may be used between the first and second surfaces. Thus, even though, for example, a glue may be provided between the first and the second surface, the first and the second surfaces may according to disclosures herein be considered to be in contact. The contact may be direct or indirect.

It shall be understood that the inlet opening and the outlet opening defining an inlet area and an outlet area, respectively, may be viewed as the area of the first or second surfaces defined by the circumferences of the inlet or outlet openings, respectively.

The second capillary flow channel may further comprise a second flow outlet arranged to emit the liquid from the second capillary flow channel. Thereby, flow of liquid out of the second microfluidic system may be enabled accordingly.

The inlet area overlapped by the outlet area being smaller than the outlet area may be realised, for example, by the inlet area being smaller than the outlet area, for which case the entire inlet area may be overlapped by the outlet area. The inlet area may, for example, be larger than the outlet area or of the same area, for which examples the outlet and the inlet may be so arranged in relation to each other that the outlet overlaps only a portion of the inlet area, which overlapped area is smaller than the outlet area.

Thus, the inlet area may have a cross-sectional area being smaller than the outlet area. Thereby, a way of enabling the outlet area overlap at least a portion of the inlet area, said at least a portion of the inlet area overlapped by the outlet area being smaller than the outlet area may efficiently be realised.
The inlet area may have a cross-sectional area being equal to or larger than the outlet area and arranged such that at least a portion of the inlet area overlapped by the outlet area is being smaller than the outlet area. Thereby, not only efficient capillary driven fluidic connection between the first and the second capillary flow channels may be realised, but also, for example, such an arrangement may benefit from reduced risks of blocking of the capillary driven flow by contaminations such as particles or precipitations which may be present in a liquid flowing from the outlet to the inlet and forward.
The outlet opening may be adapted to allow fluidic communication with the first capillary flow channel via an outlet channel, preferably having an elongation perpendicular to an elongation of the first capillary flow channel. Thereby efficient fluidic communication between the first capillary flow channel and the outlet opening, and further to the second capillary flow channel may be realised.

The inlet opening may be adapted to allow fluidic communication with the second capillary flow channel via an inlet channel, preferably having an elongation perpendicular to an elongation of the second capillary flow channel. Thereby efficient fluidic communication between the second capillary flow channel and the inlet opening, and further to the first capillary flow channel may be realised.

The outlet channel may have a cross-sectional area perpendicular to a main flow direction of the outlet channel being of same or similar size as the outlet area. The outlet area may be defined by the mouth of the outlet channel in the first surface.

The inlet channel may have a cross-sectional area perpendicular to a main flow direction of the inlet channel being of same or similar size as the inlet area. The inlet area may be defined by the mouth of the inlet channel in the second surface.

The outlet opening may have a cross-sectional area corresponding to an outlet region of the first capillary flow channel, and the inlet opening may have a cross-sectional area corresponding to an inlet region of the second capillary flow channel. Thereby, passive fluidic flows between the capillary flow channel and the inlet/outlet may be realised with reduced risk of fluidic interruptions.

Thus, the first capillary flow channel may have an outlet region and/or the second capillary flow channel may have an inlet region. The outlet area defined by the outlet opening may correspond to the outlet region of the first capillary flow channel. The inlet area defined by the inlet opening may correspond to the inlet region of the first capillary flow channel.

The outlet channel may have a cross-sectional area corresponding to the outlet region of the first capillary flow channel, and/or the inlet channel may have a cross-sectional area corresponding to the inlet region of the second capillary flow channel.

The outlet/inlet opening or channel having a cross-sectional area corresponding to an outlet/inlet region of the first/second capillary flow channel, may be described as a projection of the opening or cross-section onto a wall of the first/second capillary flow channel having a similar or corresponding shape and/or size as the outlet/inlet region. Further, according to embodiments, a width of the outlet/inlet opening may be similar, identical, or smaller, than a corresponding or parallel width of the first/second capillary channel. In other words, an inlet or outlet opening according to embodiments may be described by essentially not extending outside the inlet/outlet regions of the corresponding capillary flow channel. With embodiments of aspects of the present invention, relatively large inlets/outlets may be used, with uninterrupted capillary driven fluidic connection for reasons including the discussed overlap. It is further made possible to provide uninterrupted capillary driven fluidic connection together with efficient mating of inlet and outlet even if they are not perfectly aligned or centred. In addition, with relatively large inlets/outlets fluidic connections with relatively low resistance may be realised.

Thus, the first capillary flow channel may have an outlet region, and/or the second capillary flow channel may have an inlet region. By outlet region is meant a portion of the first capillary flow channel adjacent or in closest proximity to the outlet opening, as compared to other portions of the first capillary flow channel. By inlet region is meant a portion of the second capillary flow channel adjacent or in closest proximity to the inlet opening, as compared to other portions of the second capillary flow channel.

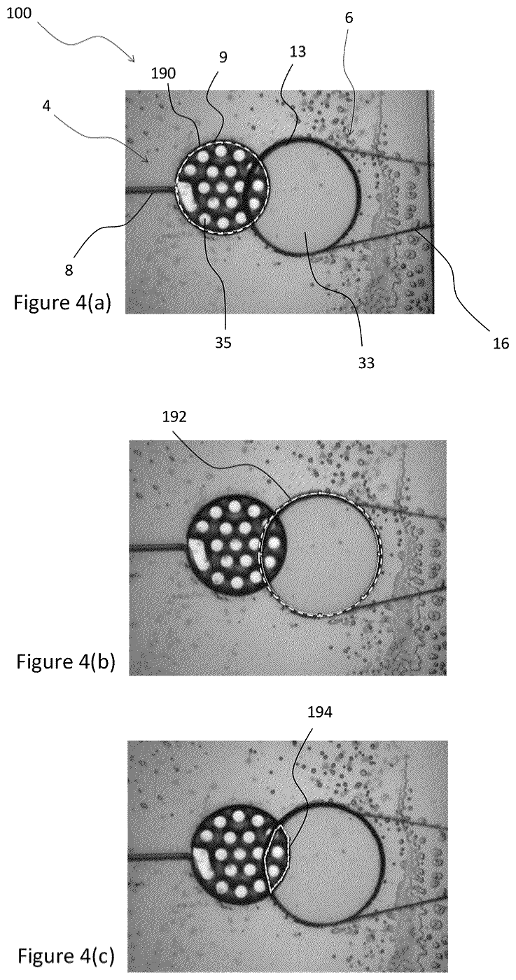

The first capillary flow channel may have an outlet region having a different width as compared to the major portion of the first capillary flow channel. For example, the first capillary flow channel may have a broadening or tapering width when approaching the outlet. According to another example, the first capillary flow channel may have an outlet region in a circular shape with a diameter which may be larger than the width of the major portion of the first capillary flow channel, for example as illustrated in FIG. 4(a). In analogy, the second capillary flow channel may have an inlet region having a different width as compared to the major portion of the second capillary flow channel, for example as illustrated in FIG. 4(a).

The microfluidic arrangement may be a passive microfluidic arrangement. With passive microfluidic arrangement is intended an arrangement as described according to the first aspect, arranged to allow all fluidic communications and flows within the arrangement to be actuated by passive capillary forces or capillary pressures, without need for eg. pressurised pumping or electrokinetic pumping, or assistance thereof. The flows in the passive microfluidic system may be actuated solely by capillary forces.
The second microfluidic system may comprise a stack of layers comprising a first layer and a second layer, and a spacer layer between the first and the second layer, wherein the second layer comprises the second surface, and a through-hole comprising the inlet opening, and is arranged to provide fluidic communication between the inlet opening and the second capillary flow channel, the spacer layer has an elongated cut-out extending in the second plane and parallel to the spacer layer, which elongated cut-out together with adjacent layers of the stack of layers is arranged to define the second capillary flow channel.

With such a stack of layers, the microfluidic system may be manufactured efficiently.

The adjacent layers may be, for example the first and the second layers, or, for example two layers selected from the first, the second, a third, a fourth, or a fifth layer, or other layers.

One or more of the adjacent layers, which may be the first and/or the second layer, may comprise or be manufactured from PET and be in a form of a foil or film, preferably PET with hydrophilic properties. With hydrophilic properties, capillary driven flows may be realised with hydrophilic or aqueous liquids. The adjacent layer may be manufactured from DS PSA, for example in form of a film or foil. The height or a dimension of the capillary flow channel may efficiently be selected or predetermined by selecting thickness of the film or foil.

The second microfluidic system may consist of the stack of layers.

For the microfluidic arrangement comprising the stack of layers, the second layer may further comprise a hole-member arranged to extend into and occupy the outlet opening and extend into and occupy at least a portion of the cut-out of the spacer layer, wherein the hole-member comprises the through-hole comprising the inlet opening.

The hole-member being arranged to extend into and occupy the outlet opening and extend into and occupy at least a portion of the cut-out of the spacer layer allows for efficient positioning of the through-hole during manufacturing of the arrangement.

The through-hole may be the inlet channel allowing fluidic communication between the inlet opening and the second capillary flow channel.

The second layer may be a layer manufactured by molding. Thereby dimensions of the through-hole or the inlet channel may be defined in the process of molding.

The microfluidic arrangement, when comprising the stack of layers, may further comprise a third layer of the stack of layers arranged between the second layer and the spacer layer, wherein the third layer comprises a through-hole arranged to allow fluidic communication between the second layer and the spacer layer.
Thus, for example, the second microfluidic system may be designed such that the second capillary flow channel are provided with properties lent by the third layer, while the second surface is provided with other properties lent by the second layer. For example, properties having effect on capillary flow in the capillary flow channel may be controlled and provided by the third layer, and properties having effect on interfacing between the first and the second microfluidic systems may be controlled and provided by the second layer.

For an example with the stack of layers consisting of a first, a second, and a third layer, and the spacer layer, the adjacent layers are the third and the first layers.

It shall be understood that any additional layers to the first, second and intermediate layers positioned between the second layer and the spacer layer, such as for example a third layer, may have through-holes that matches the through-hole of the second layer by at least partially overlapping the through-hole of the second layer, thereby enabling fluidical communication between the first and second capillary channels.

The second layer may be an adhesive layer providing adhesion between the first and second microfluidic systems and/or the first and second outer surfaces.

The layers of the stack of layers may be arranged in parallel to the second outer surface.

The first microfluidic system may comprise a stack of layers comprising a first layer and a second layer, and a spacer layer between the first and the second layer, wherein the second layer comprises the first surface, and a through-hole comprising the outlet opening, and is arranged to provide fluidic communication between the outlet opening and the first capillary flow channel, the spacer layer has an elongated cut-out extending in the first plane and parallel to the spacer layer, which elongated cut-out together with adjacent layers of the stack of layers is arranged to define the first capillary flow channel.

Thus, one of or both of the first and second micro fluidic systems may comprise, or be manufactured from, stack of layers.

When the microfluidic arrangement comprises the outlet channel and/or the inlet channel, a wall portion of the outlet channel and/or a wall portion of the inlet channel may be provided with hydrophilic property, thereby providing an effect on wetting properties of the flow outlet and/or the flow inlet.
The first microfluidic system and/or the second microfluidic system may be manufactured from material providing or being modifiable to provide the hydrophilic property. For example, the microfluidic systems may be manufactured from PET having a hydrophilic coating, such as, for example, a PET layer having a hydrophilic coating. The micro fluidic systems may also be manufactured from materials comprising chemical groups which allows modifying the material such as by chemical reaction or adsorption to have hydrophilic properties.
A capillary-driven flow of a liquid requires one or more contacting surfaces that the liquid can wet. Hydrophilic property of materials or surfaces as used herein is intended to be construed as one or more properties allowing the material or surface to be wetted by an aqueous or hydrophilic liquid. Thus, the hydrophilic property provides attractive forces between the surface or material and the liquid. Thus, the hydrophilic properties allow capillary driven flows. For example, materials comprising or consisting of glass or silica shall be understood as having hydrophilic properties for systems with capillary driven flowing of aqueous liquids. Further, for example, suitable polymers with hydrophilic properties, either inherent to the polymer or by modification, including for example chemical modification or coating, may be regarded as hydrophilic and promote or enhance capillary driven flows.
The wall portion of the outlet channel and/or the wall portion of the inlet channel may at least partially be coated with or contacted with a hydrophilicity enhancing agent. Thereby, the wall portion may provide larger attractive forces towards an aqueous solution as compared to an uncoated wall portion. Thereby, capillary driven flow may be promoted or enhanced.

The hydrophilicity enhancing agent, as used herein, may be understood as an agent which increases or enhances the hydrophilic property of the wall portion, as compared to the wall portion in absence of the hydrophilicity enhancing agent.

The hydrophilicity enhancing agent may be selected from a group consisting of SiO₂, surfactants, polymers, for example PEG, and PMOXA.

Any suitable hydrophilicity enhancing agent may be used. In addition to being selected to provide suitable enhancement of hydrophilicity, it may be selected to have suitable properties for providing a coating on the material of the inlet channel, as well as having low or no negative effect on compounds or sample present in the system.

The first and/or second microfluidic system may be manufactured from silicon, glass or polymer, or combinations thereof. Thereby, microfabrication of the microfluidic systems by known methods may be realised. Further, capillary driven flows may be realised within the arrangement.
At least one of the layers of the stack of layers may comprise material with capillary force enhancing properties or hydrophilicity enhancing properties in the second or first capillary flow channel, in particular the material may comprise or be coated with SiO₂.

The first microfluidic system and/or the second microfluidic system may be a structure comprising, for example, further capillary flow channels, reaction or reagent compartments, and/or means for connection to other systems.

The first outer surface and the second outer surface being arranged such that the flow outlet and the flow inlet are interfaced, may be, for example by positioning the first outer surface and the second outer surface facing each other such that the outlet opening and the inlet opening at least are partially overlapping.

The microfluidic arrangement may be used for medical and/or diagnostic purposes, for example in a medical and/or diagnostic device. The microfluidic arrangement may be used with complex sample matrices, for example biological matrices. Examples of liquids which may be actuated or flown within the arrangement, may be blood samples, urine samples, biological samples, or other complex and/or biological samples or liquids.

The arrangement may be particularly useful with complex sample matrices.

According to another aspect of the inventive concept, there is provided a method for manufacturing a second microfluidic system for interfacing with a first microfluidic system (4) comprising a first surface (5), and a first capillary flow channel (8), wherein the first capillary flow channel (8) has an elongation in a first plane, and the first surface comprises an outlet opening (9) in a plane different from the first plane, the outlet opening defining an outlet area (35) in the first surface and being adapted to allow fluidic communication with the first capillary flow channel thereby forming a flow outlet (12) of the first capillary flow channel, the second microfluidic system, comprising a second surface having an inlet opening, and a second capillary flow channel communicating with the inlet opening, wherein the second microfluidic system further comprises a stack of layers comprising a first layer and a second layer, and a spacer layer between the first and the second layer, the method comprising:

manufacturing the spacer layer by laser cutting an elongated cut-out in a spacer material, the elongated cut-out defining the capillary flow channel of the microfluidic system,

stacking the spacer layer with the second layer, optionally with one or more additional layers between the spacer layer and the second layer,

cutting a hole through the second layer, and optionally through the one or more additional layers, into the elongated cut-out of the spacer layer with a short pulse laser, thereby making the inlet opening communicating with the capillary flow channel,

arranging a first layer on top of the spacer layer.

The short pulse laser may be of a pico-second, a femto-second or an atto-second type of laser. Such lasers provide desirable holes, for example, holes having well defined and smooth edges. The short pulse laser may be a laser referred to as an ultra-short pulse laser.

The first and/or second capillary flow channel may comprise a coating of SiO₂. Thereby capillary driven flows may be facilitated. Further, the surface and capillary action of the first and/or second capillary flow channel may, thereby, mimic the surface and capillary action of a silica structure.

Such as first microfluidic system may suitably be connected or interfaced with the second microfluidic system according to the third aspect. For example, as is described with reference to the first aspect.

The through-hole of the second layer may have similar or identical dimensions and area as the inlet opening has

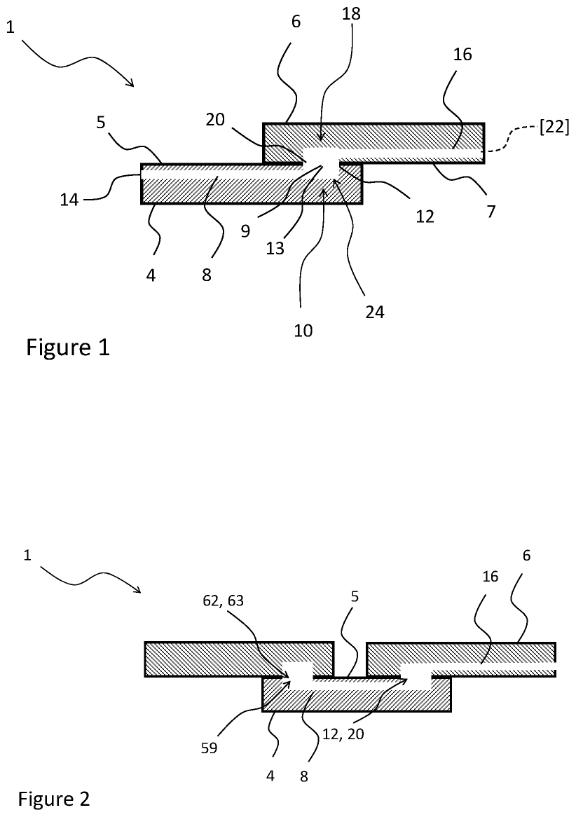

According to a third aspect of the present inventive concept, there is provided a device comprising the microfluidic arrangement according to the first aspect for medical or diagnostic use.
With reference to FIG. 1 a microfluidic arrangement 1 for capillary driven fluidic connection between capillary flow channels 8, 16 will now be discussed. The microfluidic arrangement 1 comprising a first microfluidic system 4 comprising a first surface 5, and a first capillary flow channel 8, wherein the first capillary flow channel 8 has an elongation in a first plane, and the first surface 5 comprises an outlet opening 9 in a plane different from the first plane. The outlet opening 9 defines an outlet area in the first surface 5 and being adapted to allow fluidic communication with the first capillary flow channel 8 thereby forming a flow outlet 12 of the first capillary flow channel 8, and a second microfluidic system 6 comprising a second surface 7 and a second capillary flow channel 16, wherein the second capillary flow channel 16 has an elongation in a second plane parallel to the first plane, and a portion of the second surface 7 comprises an inlet opening 13 in a plane different from the second plane, the inlet opening 13 defining an inlet area in the second surface 7 and being adapted to allow fluidic communication with the second capillary flow channel 16 thereby forming a flow inlet 20 of the second capillary flow channel 16, wherein the first microfluidic system 4 and the second microfluidic system 6 are arranged with the first and the second surfaces 5, 7 in contact such that the flow outlet 12 and the flow inlet 20 are interfaced, thereby allowing capillary driven fluidic connection between the first and the second capillary flow channels 8, 16, wherein the outlet area overlaps at least a portion of the inlet area, said at least a portion of the inlet area overlapped by the outlet area being smaller than the outlet area.

The first and the second planes may further be parallel to the first and/or second surface.

The outlet opening 9 being adapted to allow fluidic communication with the first capillary flow channel, may be by means of a channel communicating with the first capillary flow channel 8. The inlet opening 13 being adapted to allow fluidic communication with the second capillary flow channel 16, may be by means of a channel communicating with the second capillary flow channel.

In FIG. 1, the arrangement 1 is illustrated with the first microfluidic system 4 and the second microfluidic system 6 having one capillary flow channel each. According to other embodiments a plurality of flow channels may be comprised on the first microfluidic system 4 and/or the second microfluidic system 6.

The dimensions of the capillary flow channels 8, 16 are schematically illustrated. Dimensions of the first and second capillary flow channels 8, 16 may be selected to provide desired capillary forces, and dimensions may be selected differently and dependent on, for example, the properties of the liquid and/or material and/or properties of walls of the first and second capillary flow channels 8, 16. A cross-sectional shape of the first and/or the second capillary flow channels 8, 16 may be individually selected from, for example, rectangular, square, or circular. One or more dimensions, such as for example widths or heights, of the cross-sectional shape of the first and/or the second capillary flow channels 8, 16 may be 1 micrometre or above, such as 1 to 1000 micrometres. Thereby, suitable dimensions of the first and/or the second flow channels may be provided. In addition to the one or more dimensions, the first and/or the second flow channels may have one or more further dimension, being larger than the one or more dimensions.

The flow outlet 12 and the flow inlet 20 being interfaced may be described by that the outlet opening 9 and the inlet opening 13 at least partly are overlapping. Thereby, fluidic connection may be enabled between the first and the second microfluidic systems 4, 6 and the first and the second capillary flow channels 8, 16.

The first flow outlet 12 and the second flow inlet 20, may be holes or openings through walls of the first and second microfluidic systems 4, 6 comprising the first and second surfaces 5, 7 of the first microfluidic system 4 and the second microfluidic system 6, respectively, the openings having a mouth in the first capillary flow channel 8 and the second capillary flow channel 16, respectively. Thereby, interfacing may be realised by placing the walls contacted with each other and the holes or openings at least partly overlapping.

The second capillary flow channel 16 may further comprise an optional second flow outlet 22 arranged to emit liquid from the second capillary flow channel 16. The second flow outlet 22 is indicated in FIG. 1 with a dashed line and with a reference number within brackets, to illustrate that it is optional.

The inlet area overlapped by the outlet area being smaller than the outlet area, may be wherein the area overlapped may be 90% or below the outlet area, 75% or below; or 50% or below. The area overlapped may be above 10% of the outlet area. For example, the overlapped area may be in the range from 90% to 10%, or 90% to 25%, of the outlet area.

According to one example, circular shaped outlet and inlet were used, having, for this particular example, diameters of 500 and 300 micrometres, respectively. In the example, the entire inlet was overlapped by the outlet, whereby the area overlapped was 36% of the outlet area. Such an overlap is one example which resulted in desirable fluidic connection between capillary flow channels without undesired stop in capillary flow.

The first microfluidic system 4 and/or the second microfluidic system 6 may be manufactured from material providing or being modifiable to provide hydrophilic properties in areas or surfaces where the capillary driven flow is desired. For example, such areas or surfaces may comprise or be modifiable to comprise hydrophilic groups such as SiO₂ groups.

The microfluidic arrangement 1 comprises outlet and inlet openings. When using the microfluidic arrangement 1 for transferring liquid, the arrangement may beneficially be used such that liquid is actuated by capillary forces from the first to the second capillary flow channels 8, 16, thereby taking advantage of said at least a portion of the inlet area overlapped by the outlet area being smaller than the outlet area. Transferring liquid in the opposite direction may be possible but may suffer from disadvantages and lack benefits of the present inventive concept. It will therefore be appreciated that inlet and outlet as used herein is intended to refer to flow during normal intended use of the arrangement going in a direction from outlet to inlet, although the flow may be actuated in opposite direction.

It will be appreciated that the microfluidic arrangement 1 and the first and second microfluidic systems 4, 6 may comprise further microfluidic connections and interfaces, in addition to the interface between the flow outlet 12 and the flow inlet 20. For example, according to the following discussion with reference to FIG. 2, which illustrates the microfluidic arrangement 1 according to an embodiment. The first surface 5 may further comprise a second inlet opening 59 in a plane different from the first plane. The second inlet opening 59 may define a second inlet area in the first surface 5 and being adapted to allow fluidic communication with the first capillary flow channel 8 thereby forming a second flow inlet 62 of the first capillary flow channel 8. This second flow inlet 62 may be connected or interfaced with a second flow outlet 63 from the second microfluidic system 6 or from another additional microfluidic system. The interface between the second flow inlet and the second flow outlet may be characterised in analogy with the interface and overlap between the outlet area and the inlet area as discussed with reference to FIG. 1. Although not illustrated in FIG. 2, the second flow outlet 63 may be fluidically communicating with a flow channel, such as a third microfluidic flow channel.

The first plane is a plane at which the first capillary flow channel 8 has an elongation. The first plane may be parallel to the first surface 5. The second plane is a plane at which the second capillary flow channel 16 has an elongation. The second plane may be parallel to the first and/or second surface.

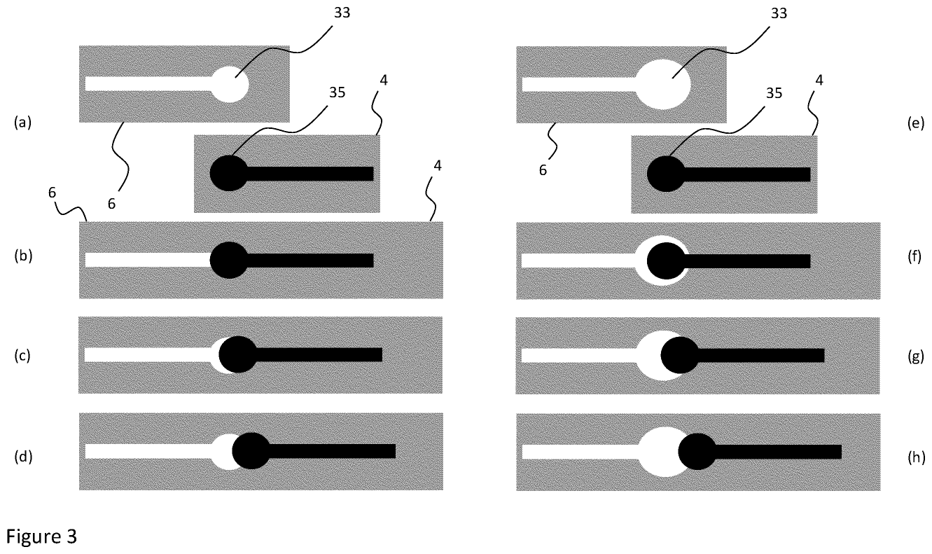

With references to FIGS. 3(a)-(h), the interface between the flow outlet 12 and the flow inlet 20 will now be discussed. Only a portion of the arrangement 1, for example the arrangement discussed with reference to FIG. 1, is illustrated in FIGS. 3(a)-(h) in an attempt to improve clarity. The portion of the arrangement 1 is illustrates in a top view, wherein the first microfluidic system 4 is illustrated on top of the second microfluidic system 6, except in FIGS. 3(a) and (e), where the microfluidic systems 4, 6 are illustrated side by side. The first capillary flow channel 8 is illustrated in black and the second capillary flow channel 16 is illustrated in white. The outlet opening 9 and the inlet opening 13 each are illustrated having a circular cross-sectional shape corresponding to the outlet area 35 and the inlet area 33, respectively, but it will be understood and appreciated that the shapes are only illustrating examples. Cross sectional areas of the inlet opening and the outlet opening, and the inlet area 33 and the outlet area 35 may further be, for example, independently selected from squared, rectangular, triangular, polygonal, oval, or star-shaped. Further, the inlet and outlet being wider than the capillary flow channels are only examples in the illustrations, they may alternatively and independently be of same or smaller widths. The inlet area 33 and the outlet area 35 in FIGS. 3(a)-(d) are identical. In FIGS. 3(e)-(h) the inlet area 33 is larger than the outlet area 35, in the illustrated examples approximately two times larger. FIGS. 3(b) and (f) illustrates a comparative example wherein the area overlapped is 100% of the outlet area 35, thus not smaller than the outlet area 35. FIG. 3(c) illustrates an example according to an embodiment, where the area overlapped is smaller than the outlet area 35. FIG. 3(d) also illustrates an example according to an embodiment, where the area overlapped is smaller than the outlet area 35, and smaller than the overlapped area in FIG. 3(c). Thus, the area overlapped being smaller than the outlet area 35 may be realised with the inlet area 33 being of same size as the outlet area 35. It has surprisingly been found that such an overlapped area provides efficient fluidic connections for capillary driven flows, even for large inlet areas 33.

FIGS. 3(e)-(h) illustrates arrangements 1 wherein the inlet area 33 is larger than the outlet area 35. Interfacing capillary flow channels with such inlet and outlet areas 33, 35 is problematic and may result, for example, in blockage of a capillary driven flow. The comparative example illustrated in FIG. 3(f), wherein the overlapped area is 100% of the outlet area, may suffer from problems with the flow. FIGS. 3(g) and (h) illustrates embodiments wherein the area overlapped is smaller than the outlet area 35, and which unexpectedly may provide efficient fluidic connection with maintained capillary driven flows, even though the inlet area 33 is larger than the outlet area 35. Such embodiments wherein the inlet area is larger than the outlet area benefits from easier manufacturing while still efficient capillary connection can be achieved.

With reference to FIGS. 4(a)-(c), embodiments will now be discussed with reference to conducted experiments illustrating benefits with at least a portion of the inlet area 33 overlapped by the outlet area 35 being smaller than the outlet area 35. A portion 100 of the arrangement 1 having the interface between the first flow outlet 12 and the second flow inlet 20 is depicted in FIG. 4(a)-(c), illustrating the experimental set up. A portion of the first microfluidic system 4 comprising the first capillary flow channel 8 having an outlet opening 9 defining an outlet area 35 can be seen in FIG. 4(a). A white dotted circle 190 has been drawn in FIG. 4(a) to emphasise the outlet area 35. Further seen in FIGS. 4(a)-(c) is a portion of the second microfluidic system 6 comprising a second capillary flow channel 16 having an inlet opening 13 defining an inlet area 33. A white dotted circle 192 has been drawn in FIG. 4(b) to emphasise the inlet area 33. Experiments were conducted wherein the outlet area 35 overlaps portions of the inlet area 33. The approximate inlet area 33 overlapped by the outlet area 35 has been emphasised in FIG. 4(c) as the area surrounded by the white compilation of lines 194.

By adjusting the first microfluidic system 4 and the second microfluidic system 6 in relation to each other, different overlaps were obtained and tested for fluidic connection. In the experiments three parallel first and second microfluidic systems were used to increase number of generated experimental data, referred to as System 1, System 2, and System 3 in Table 1. The experiments were judged based on successful fluidic connection, i.e. visually confirmed fluidic transfer from the first capillary flow channel 8, via the outlet opening 9 to the inlet opening 13, to the second capillary flow channel 16. Only passive liquid flowing was employed, i.e. driven by capillary forces. Aqueous buffer was used, referred in the experiments as lysing buffer.
Notably from FIGS. 4(a)-(c), the inlet opening 13 is larger than the outlet opening, which may be expected to make passive fluidic connection difficult, and initial experiments showed that perfectly aligned outlets and inlets, wherein the overlapped area is 100% of the outlet area, were not successful or could not be conducted without problem.
In calculations based on the experimental data, the areas approximately indicated by white dotted circles or lines 190, 192, or 194 were calculated using software and used for calculating the overlap as percent of the outlet area. Results of experiments and calculations are provided in Table 1.

TABLE 2
Data from Experiments.

| | | System 1 | System 2 | System 3 |
|---|---|---|---|---|
| Test 1 | Outlet area | 12970 | 12768 | 12980 |
| | Inlet area | 20216 | 18856 | 19250 |
| | Area Overlap | 1860 | 5770 | 2321 |
| | Overlap of inlet | 9.2% | 30.6% | 12.1% |
| | Overlap of outlet | 14.3% | 45.2% | 17.9% |
| test 2 | Outlet area | 12980 | 13576 | 13064 |
| | Inlet area | 19611 | 19123 | 20360 |
| | Area Overlap | 1325 | 6422 | 2056 |
| | Overlap of inlet | 6.8% | 33.6% | 10.1% |
| | Overlap of outlet | 10.2% | 47.3% | 15.7% |
| Test 3 | Outlet area | 13477 | 13588 | 12677 |
| | Inlet area | 20224 | 18750 | 19865 |
| | Area Overlap | 179 | 6118 | 533 |
| | Overlap of inlet | 0.9% | 32.6% | 2.7% |
| | Overlap of outlet | 1.3% | 45.0% | 4.2% |
| Test 4 | Outlet area | 12892 | miss aligned | 12766 |
| | Inlet area | 20360 | miss aligned | 21000 |
| | Area Overlap | 8065 | miss aligned | 8006 |
| | Overlap of inlet | 39.6% | missaligned | 38.1% |
| | Overlap of outlet | 62.6% | missaligned | 62.7% |
| Test 5 | Outlet area | 12980 | 13692 | 12892 |
| | Inlet area | 19744 | 19365 | 19726 |
| | Area Overlap | 4301 | 2495 | 3716 |
| | Overlap of inlet | 21.8% | 12.9% | 18.8% |
| | Overlap of outlet | 33.1% | 18.2% | 28.8% |
| Test 6 | Outlet area | 12566 | 12875 | 12768 |
| | Inlet area | 19868 | 19992 | 19140 |
| | Area Overlap | 1167 | 6432 | 1840 |
| | Overlap of inlet | 5.9% | 32.2% | 9.6% |
| | Overlap of outlet | 9.3% | 50.0% | 14.4% |
| Test 7 | Outlet area | 13588 | 13170 | 13598 |
| | Inlet area | 20224 | 19482 | 20868 |
| | Area Overlap | 1601 | 3255 | 2376 |
| | Overlap of inlet | 7.9% | 16.7% | 11.4% |
| | Overlap of outlet | 11.8% | 24.7% | 17.5% |
| Test 8 | Outlet area | 13084 | 13166 | 13802 |
| | Inlet area | 19240 | 20478 | 20100 |
| | Area Overlap | 3276 | 4776 | 2594 |
| | Overlap of inlet | 17.0% | 23.3% | 12.9% |
| | Overlap of outlet | 25.0% | 36.3% | 18.8% |
| Test 9 | Outlet area | 13081 | 13170 | miss aligned |
| | Inlet area | 19740 | 19988 | miss aligned |
| | Area Overlap | 420 | 7626 | miss aligned |
| | Overlap of inlet | 2.1% | 38.2% | missaligned |
| | Overlap of outlet | 3.2% | 57.9% | missaligned |
| Test 10 | Outlet area | 13081 | 13473 | 14316 |
| | Inlet area | 20108 | 20889 | 19868 |
| | Area Overlap | 3867 | 3279 | 468 |
| | Overlap of inlet | 19.2% | 15.7% | 2.4% |
| | Overlap of outlet | 29.6% | 24.3% | 3.3% |

Notably, all experiments were considered successful and providing desired fluidic connection, except where misalignment occurred, which misalignment may be viewed as 0% overlap, and further except where the overlap was 100% of the outlet area. Thereby it may be concluded that as long as there is an overlap of the inlet area and as long as the overlap is up to 100% of the outlet area, the fluidic connection was successful. The present invention, thus, provides for reliable and efficient passive capillary driven fluidic connection even when going from a smaller outlet to a larger inlet. One would expect problems with the fluidic connection when going from a smaller outlet to a larger inlet. The unexpected finding with embodiments of the present invention may be based, at least in part, on the edges of the inlet/outlet or inlet channel/outlet channel, promoting capillary forces and creating an effect of the inlet behaving at least in part as if it was of similar size as the outlet and that the front of the flow therefore at least to a smaller extent is in an environment which does not behave or appear as entering a wider channel.

In the example of microfluidic arrangement depicted in FIGS. 4(a)-(c), the outlet channel has a cross-sectional area corresponding to an outlet region of the first capillary flow channel, and the inlet channel has a cross-sectional area corresponding to an inlet region of the second capillary flow channel. Further, in the example, the inlet area corresponds to the inlet region and the outlet area corresponds to the outlet region. In the FIGS. 4(a)-4(c), white dotted circle 190 may also be viewed as indicating the outlet region, and white dotted circle 190 may also be viewed as indicating the inlet region of the illustrated arrangement.

Variations in areas of a single outlet between tests results from calculations of the areas for each test, not from actual variations of the inlet or outlet.

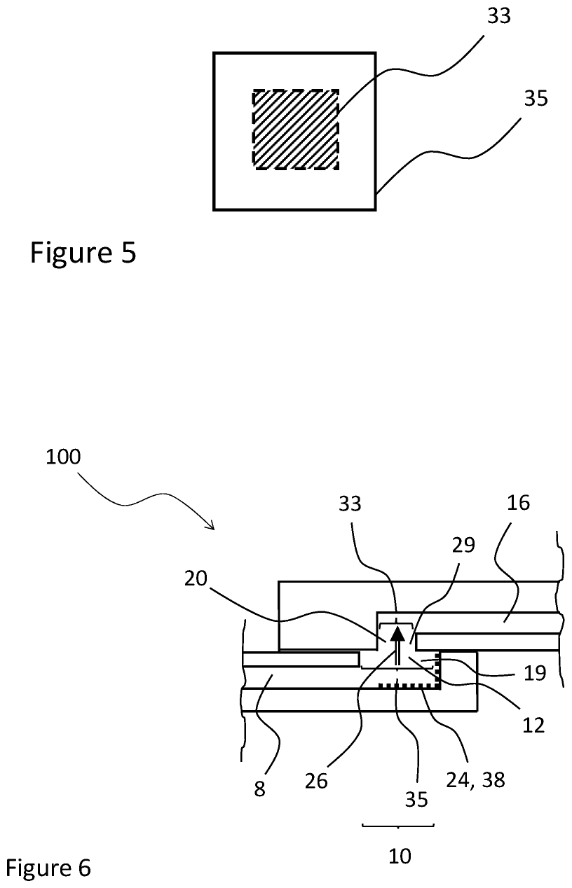

FIG. 5 illustrates the inlet area 33 and the outlet area 35 of the arrangement 1, drawn as a dashed rectangle and a solid line rectangle, respectively, wherein the first microfluidic system 4 is illustrated on top of the second microfluidic system 6. Other parts of the arrangement 1 such as the capillary flow channels 8, 16 have not been illustrated. The embodiment illustrated in FIG. 5 has the outlet area 35 overlapping at least a portion of the inlet area 33, said at least a portion of the inlet area 33 overlapped by the outlet area 35 being smaller than the outlet area 35. The inlet area 33 overlapped by the outlet area 35 is illustrates with diagonal stripes. Thus, one way to achieve the inlet area 33 overlapped by the outlet area 35 being smaller than the outlet area 35 is by the inlet area 33 being smaller than the outlet area 35.

For example, as illustrated in FIG. 5, said at least a portion of the inlet area 33 may be 100% of the inlet area 33.

As illustrated in FIGS. 3(c) and (d), the inlet area 33 and the outlet area 35 may have identical sizes, and in addition, as illustrated by FIGS. 3, (g) and (h), the outlet area may be smaller than the inlet area, whereby a portion of the inlet area is overlapped, such that said at least a portion of the inlet area 33 overlapped by the outlet area 35 is being smaller than the outlet area 35. It shall, thus, be appreciated that the inlet area 33 and the outlet area 35 may be of different sizes in relation to each other, one may be larger than the other and vice versa, or of same size, and the entire, or a portion of, the inlet area 33 may be overlapped by the outlet area 35, as long as the proviso of said at least a portion of the inlet area 33 overlapped by the outlet area 35, being smaller than the outlet area 35 is realised.

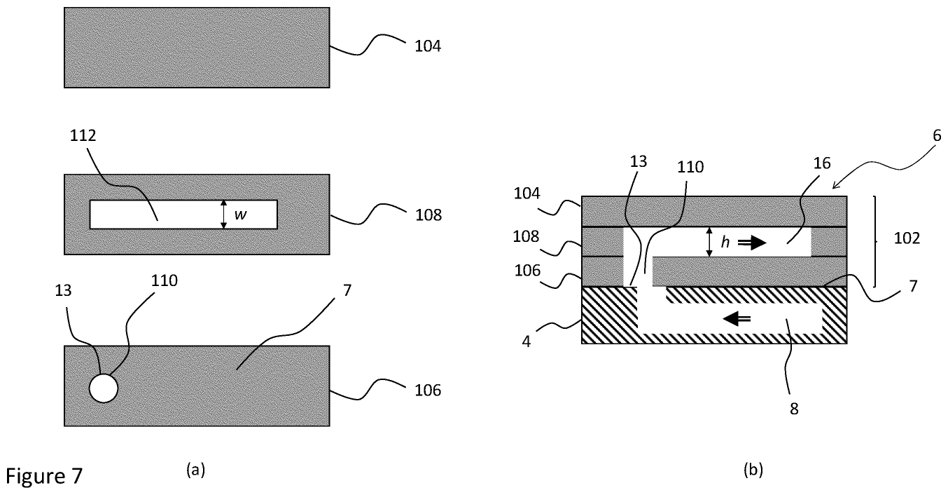

With reference to FIG. 6 the microfluidic arrangement 1 according to different embodiments of the arrangement 1 will now be described and illustrated with cross-sectional views. In FIG. 6 only a portion 100 of the arrangement 1 having the interface between the first flow outlet 12 and the second flow inlet 20 is illustrated. In FIG. 6 the flow inlet 20 has an inlet area 33, which in the illustrated example corresponds to a cross-sectional area of the flow inlet 20 perpendicular to a flow direction 26 at the second flow inlet 20, being overlapped by the outlet area 35. The inlet area 33 overlapped by the outlet area 35 is smaller than the outlet area 35, thereby capillary forces actuating liquid into the second capillary flow channel 16 may be enhanced. In FIG. 6, a wall portion 24 of the outlet channel 19 and the outlet region 10 is at least partially coated with hydrophilicity enhancing agent 38, thereby providing an effect on wetting properties of the first flow outlet 12. It shall be appreciated that liquid actuated through the first capillary flow channel 8 by capillary action more efficiently may wet and fill out the outlet region 10 and the first flow outlet 12 by contacting the hydrophilicity enhancing agent 38, and thereby the liquid being brought in contact with the second flow inlet 20 of the second capillary flow channel 16. In the illustrated example, further actuation of the liquid, by capillary action, from the flow outlet 12 into the flow inlet 20 is further facilitated or enhanced by the outlet area 35 overlapping at least a portion of the inlet area 33, said at least a portion of the inlet area 33 overlapped by the outlet area 35 being smaller than the outlet area 35. A larger cross-sectional area of one of the flow outlet 12 or the flow inlet 20, compared to the other, may provide for efficient overlapping and interfacing of the first flow outlet 12 and the second flow inlet 20. The inlet area 33 being smaller than the outlet area 35 is one efficient way of achieving the area overlapped being smaller than the outlet area 35. Thereby, capillary forces actuating liquid into the second capillary flow channel 12 may be enhanced by provision of narrower flow channels at the interface and increased wall surface area.
The outlet opening 9 may, as illustrated, be adapted to allow fluidic communication with the first capillary flow channel 8 via the outlet channel 19, and the inlet opening 13 may, as illustrated, be adapted to allow fluidic communication with the second capillary flow channel via an inlet channel 29. The inlet channel 29, as illustrated, may preferably have an elongation perpendicular to an elongation of the second capillary flow channel. And the outlet channel, as illustrated, may preferably have an elongation perpendicular to an elongation of the first capillary flow channel.
With reference to FIGS. 7(a) and (b), the microfluidic arrangement 1, wherein the second microfluidic system 6 comprises a stack 102 of layers will now be discussed. Capillary flows in the microfluidic arrangement 1 during one intended or typical use of the microfluidic arrangements 1 is schematically illustrated by arrows within the capillary flow channels 6, 8. FIG. 7(a) illustrates parts and details of the microfluidic arrangement separated from each other and illustrated in a top view, while FIG. 7(b) illustrates a side view of the microfluidic arrangement 1 comprising parts and details illustrated in FIG. 7(a). The stack 102 of layers comprises a first layer 104 and a second layer 106, and a spacer layer 108 between the first and the second layers 104, 106. The second layer 106 comprises the second surface 7, and a through-hole 110 comprising the inlet opening 13 and is arranged to provide fluidic communication between the inlet opening 13 and the second capillary flow channel 16. The spacer layer 108 has an elongated cut-out 112 extending in the second plane and parallel to the spacer layer, which elongated cut-out 112 together with adjacent layers of the stack 102 of layers is arranged to define the second capillary flow channel 16. The adjacent layers in the illustrated embodiment corresponds to the first and the second layers 104, 106. It shall be clear from FIGS. 7(a) and (b) that the dimensions of the second capillary flow channel is determined or defined by the elongated cut-out 112 and the thickness of the intermediate layer 108, including the width, w, of the elongated cut-out 112, which defines the width of the second capillary flow channel, and the thickness of the intermediate layer 108, which defines the height, h, of the second capillary flow channel 16. In the illustrated example, w is 300 micrometres and h is 40 micrometres. Further illustrated in FIG. 7(b), but not in FIG. 7(a) is the first microfluidic system 4 comprising a first capillary flow channel 8. In the illustrated example, the first microfluidic system 4 is exemplified comprising a flow outlet having an outlet area 35 being of same size as the inlet area 33 but overlapping only a portion of the inlet area 33, which portion being smaller than the outlet area 35. The first microfluidic system 4 and the second microfluidic system 6 are arranged with the first and the second surfaces 5, 7, in contact. Suitably (not illustrated) the first and the second surfaces 5, 7, and thereby the first and second microfluidic systems 4, 6 may be contacted, for example, by gluing or by adhesion. For example, the second layer 106 may have adhesive properties, such as by being manufactured from an adhesive base tape. Such a tape may be, for example, DS PSA base tape, suitably with a thickness between 10 and 100 micrometres, for example 40 micrometres.

Although the first microfluidic system 4 is not illustrated to comprise a stack of layers in FIG. 7(b), the first microfluidic system 4 may comprise, independent of if the second microfluidic system 6 comprises a stack 102 of layers or not, a stack of layers comprising a first layer and a second layer, and a spacer layer between the first and the second layer, wherein the second layer comprises the first surface, and a through-hole comprising the outlet opening, and is arranged to provide fluidic communication between the outlet opening and the first capillary flow channel 8. The spacer layer of the stack of layers of the first capillary system, may have an elongated cut-out extending in the first plane and parallel to the spacer layer, which elongated cut-out together with adjacent layers of the stack of layers is arranged to define the first capillary flow channel 8.

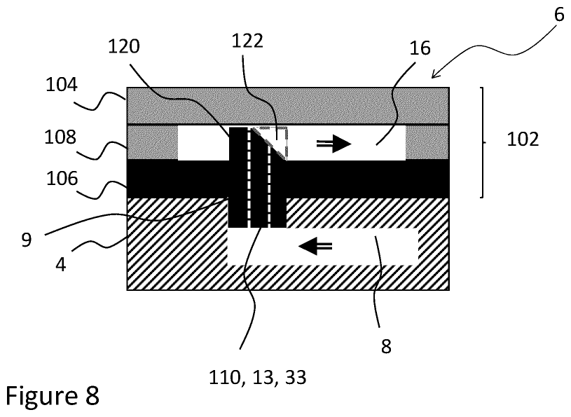

A microfluidic arrangement 1 comprising the stack 102 of layers, wherein the second layer 106 further comprises a hole-member 120 will now be discussed with reference to FIG. 8. Illustrated in FIG. 8 is the second microfluidic system 6 and the first microfluidic system 4, and the stack 102 of layers comprising the first layer 104 and a second layer 106, and a spacer layer 108 between the first and the second layers. The first and second capillary flow channels 8, 16 are arranged similarly to the arrangement illustrated in FIG. 7, although it will be appreciated that they may be arranged with, for example, different directions. The second layer 106 further comprises the hole-member 120 arranged to extend into and occupy the outlet opening 9 and extend into and occupy at least a portion of the cut-out 112 of the spacer layer 108, wherein the hole-member 120 comprises the through-hole 110 comprising the inlet opening 13. The through-hole is illustrated using dotted white lines. As may be seen in FIG. 8, the through-hole 110 provides a fluid communication or channel between the first and the second capillary flow channels 8, 16, by means of a mouth 122 into the second capillary flow channel 16 facilitated by a cut-off portion 122 of the hole-member 120, which mouth or cut-off portion 122 provides a flow-passage between the through-hole 110 and the second capillary flow channel 16. The cut-off portion 122 is illustrated with a grey dotted line. It is realised that different suitable ways of providing the mouth 122 and fluidic communication between the through-hole 110 and the second capillary flow channel 16 may be used, in addition to the cut-off 122, such as, for example, flow channels or holes. The illustrated hole member 120 is circular-cylindrically shaped to suitably allow being arranged to extend into and occupy the outlet opening 9, which in the example is circular in shape, and further to extend into and occupy at least a portion of the cut-out 112 of the spacer layer 108. For example, if the outlet opening 9 is rectangular, the hole-member 120 may have a portion with rectangularly shaped cross-section extending into the outlet opening 9.

With the hole-member 120 comprising the through-hole 110 comprising the inlet opening 13; the outlet area 35 efficiently overlaps the inlet area 33, the inlet area 33 overlapped by the outlet area 35 being smaller than the outlet area 35.

Interfacing the first and second micro fluidic systems is easy with the hole-member 120 extending into the out-let opening 9.

The second layer 106 further comprises a hole-member 120, may suitably be manufactured in one piece, preferably by a moulding process. The second layer 106 further comprising the hole-member may alternatively be manufactured from a material which may be provided with hydrophilic or capillary driven flow-facilitating properties, such as by surface modification within the through-hole 110. As seen in FIG. 8 the second surface may be essentially plane, but with the hole-member protruding from the second surface 7.

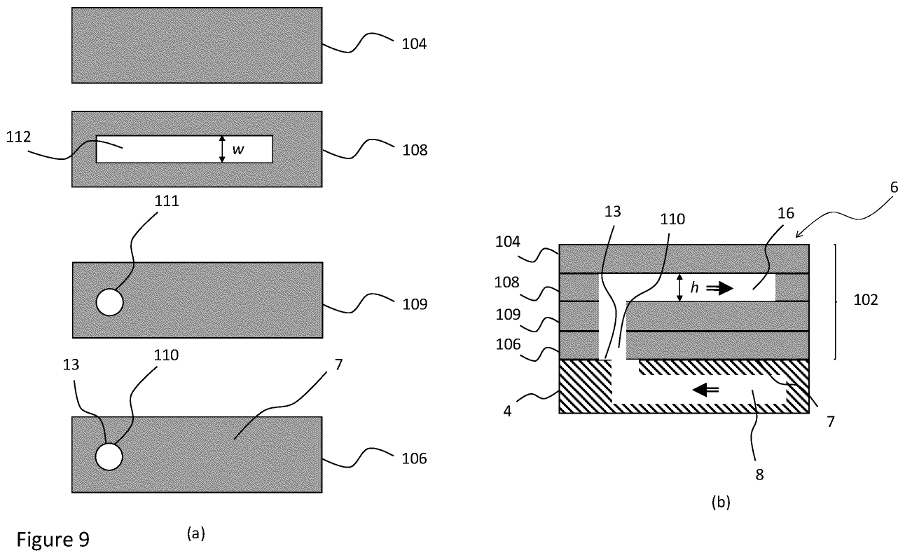

With reference to FIGS. 9(a) and (b), the microfluidic arrangement 1 similar to the microfluidic arrangement 1 discussed with reference to FIGS. 9(a) and (b) but differing in that it comprises an additional, third, 109 layer in the stack 102 of layers of the second microfluidic system 6 will now be discussed. The stack 102 of layers further comprises a third layer 109 of the stack 102 of layers arranged between the second layer 106 and the spacer layer 109, wherein the third layer 109 comprises a through-hole 111 arranged to allow fluidic communication between the second layer 106 and the spacer layer 108. With such an arrangement, the second layer 6 may be a binding layer, such as made from an adhesive tape. In the illustrated example, with the stack 102 of layers consisting of a first layer 104, a second layer 106, and a third layer 109, and the spacer layer 108, the adjacent layers are the third layer 109 and the first layer 104.
Suitably, for embodiments of the present inventive concepts, the first and/or second microfluidic system 4, 6 may be manufactured from silicon, glass or polymer, or combinations thereof.

For embodiments comprising the stack 102 of layers, at least one of the layers of the stack of layers 102 may comprise material with capillary force enhancing properties in the second capillary flow channel, in particular the material may comprise or be coated with SiO₂.

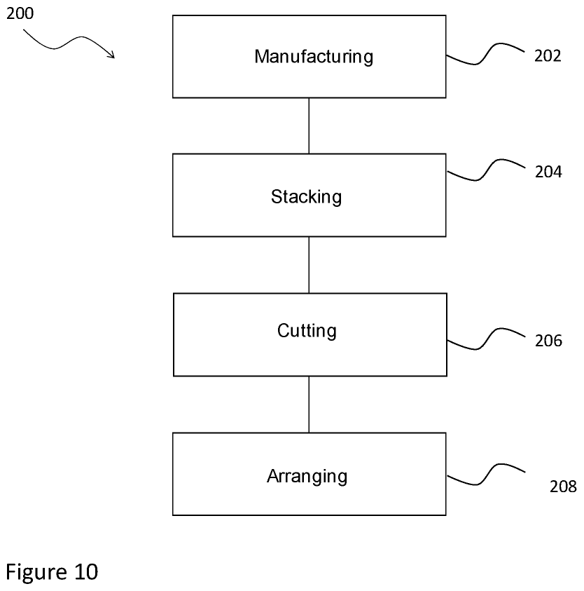

With reference to FIG. 10, a method 200 for manufacturing a microfluidic system, which may, for example, be the first or the second microfluidic systems 4, 6, will now be discussed. The microfluidic system comprises a surface having an inlet opening, and a capillary flow channel communicating with the inlet opening, wherein the microfluidic system comprises a stack of layers comprising a first layer and a second layer, and a spacer layer between the first and the second layer, the method comprising:

Manufacturing 202 the spacer layer by laser cutting an elongated cut-out in a spacer material, the elongated cut-out defining the capillary flow channel of the microfluidic system,

Stacking 204 the spacer layer with the second layer, optionally with one or more additional layers between the spacer layer and the second layer,

Cutting 206 a hole through the second layer, and optionally through the one or more additional layers, into the elongated cut-out of the spacer layer with a short pulse laser, thereby making the inlet opening communicating with the capillary flow channel,

Arranging 208 a first layer on top of the spacer layer.

The use of a short pulse laser provides improved properties of the hole including smooth edges.

The short pulse laser may be, for example, a pico-second, a femto-second or an atto-second type of laser.

In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A microfluidic arrangement for capillary driven fluidic connection between capillary flow channels, the microfluidic arrangement comprising:
a first microfluidic system comprising a first surface, and a first capillary flow channel, wherein
the first capillary flow channel has an elongation in a first plane, and
the first surface comprises an outlet opening in a plane different from the first plane, the outlet opening defining an outlet area in the first surface and being adapted to allow fluidic communication with the first capillary flow channel thereby forming a flow outlet of the first capillary flow channel,
and
a second microfluidic system comprising a second surface and a second capillary flow channel, wherein
the second capillary flow channel has an elongation in a second plane parallel to the first plane, and
a portion of the second surface comprises an inlet opening in a plane different from the second plane, the inlet opening defining an inlet area in the second surface and being adapted to allow fluidic communication with the second capillary flow channel thereby forming a flow inlet of the second capillary flow channel,
wherein the first microfluidic system and the second microfluidic system are arranged with the first and the second surfaces in contact such that the flow outlet and the flow inlet are interfaced, thereby allowing capillary driven fluidic connection between the first and the second capillary flow channels, wherein
the outlet area overlaps at least a portion of the inlet area, said at least a portion of the inlet area overlapped by the outlet area being smaller than the outlet area.

2. The microfluidic arrangement according to claim 1, wherein the inlet area has a cross-sectional area being smaller than the outlet area.

3. The microfluidic arrangement according to claim 1, wherein
the outlet opening is adapted to allow fluidic communication with the first capillary flow channel via an outlet channel, preferably having an elongation perpendicular to an elongation of the first capillary flow channel, and
the inlet opening is adapted to allow fluidic communication with the second capillary flow channel via an inlet channel 29, preferably having an elongation perpendicular to an elongation of the second capillary flow channel.

4. The microfluidic arrangement according to claim 1, wherein
the outlet opening has a cross-sectional area corresponding to an outlet region of the first capillary flow channel, and
the inlet opening has a cross-sectional area corresponding to an inlet region of the second capillary flow channel.

5. The microfluidic arrangement according to any one of the previous claims, wherein the second microfluidic system comprises a stack of layers comprising a first layer and a second layer, and a spacer layer between the first and the second layers,
wherein the second layer comprises the second surface, and a through-hole comprising the inlet opening, and is arranged to provide fluidic communication between the inlet opening and the second capillary flow channel,
the spacer layer has an elongated cut-out extending in the second plane and parallel to the spacer layer, which elongated cut-out together with adjacent layers of the stack of layers is arranged to define the second capillary flow channel.

6. The microfluidic arrangement according to claim 5, wherein the second layer further comprises a hole-member arranged to extend into and occupy the outlet opening and extend into and occupy at least a portion of the cut-out of the spacer layer, wherein the hole-member comprises the through-hole comprising the inlet opening.

7. The microfluidic arrangement according to claim 5, further comprising a third layer of the stack of layers arranged between the second layer and the spacer layer, wherein the third layer comprises a through-hole arranged to allow fluidic communication between the second layer and the spacer layer.

8. The microfluidic arrangement according to claim 1, wherein the first microfluidic system comprises a stack of layers comprising a first layer and a second layer, and a spacer layer between the first and the second layer,
wherein the second layer comprises the first surface, and a through-hole comprising the outlet opening, and is arranged to provide fluidic communication between the outlet opening and the first capillary flow channel,
the spacer layer has an elongated cut-out extending in the first plane and parallel to the spacer layer, which elongated cut-out together with adjacent layers of the stack of layers is arranged to define the first capillary flow channel.

9. The microfluidic arrangement according to claim 3, wherein
a wall portion of the outlet channel and/or a wall portion of the inlet channel is provided with hydrophilic property, thereby providing an effect on wetting properties of the flow outlet and/or the flow inlet.

10. The microfluidic arrangement according to claim 9, wherein the first microfluidic system and/or the second microfluidic system is manufactured from material providing or being modifiable to provide the hydrophilic property.

11. The microfluidic arrangement according to claim 10, wherein the wall portion of the outlet channel and/or the wall portion of the inlet channel is at least partially coated with or contacted with a hydrophilicity enhancing agent.

12. The microfluidic arrangement according to claim 11, wherein the hydrophilicity enhancing agent is selected from a group consisting of SiO₂, surfactants, PEG, and PMOXA.

13. The microfluidic arrangement according to claim 1, wherein the first and/or second microfluidic system is manufactured from silicon, glass or polymer, or combinations thereof.

14. The microfluidic arrangement according to claim 5, wherein at least one of the layers of the stack of layers comprises material with capillary force enhancing properties in the second capillary flow channel, in particular the material comprises or is coated with SiO₂.

15. A method for manufacturing a second microfluidic system for interfacing with a first microfluidic system comprising a first surface, and a first capillary flow channel, wherein the first capillary flow channel has an elongation in a first plane, and the first surface comprises an outlet opening in a plane different from the first plane, the outlet opening defining an outlet area in the first surface and being adapted to allow fluidic communication with the first capillary flow channel thereby forming a flow outlet of the first capillary flow channel, the second microfluidic system comprising a second surface having an inlet opening, and a second capillary flow channel communicating with the inlet opening, wherein the second microfluidic system further comprises a stack of layers comprising a first layer and a second layer, and a spacer layer between the first and the second layer, the method comprising:
manufacturing the spacer layer by laser cutting an elongated cut-out in a spacer material, the elongated cut-out defining the capillary flow channel of the microfluidic system,
stacking the spacer layer with the second layer, optionally with one or more additional layers between the spacer layer and the second layer,
cutting a hole through the second layer, and optionally through the one or more additional layers, into the elongated cut-out of the spacer layer with a short pulse laser, thereby making the inlet opening communicating with the capillary flow channel, and
arranging a first layer on top of the spacer layer.

16. A device comprising the microfluidic arrangement according to claim 1 for medical or diagnostic use.
